(19) United States
(12) Patent Application Publication
(10) Pub. No.: US 2009/0256382 A1
(43) Pub. Date: Oct. 15, 2009

(54) One-piece aerodynamic truck bed enclosure

(76) Inventor: Barry C. Stum, Cairo, MO (US)

Correspondence Address: Jasen S. Matyas;Rogers, Ehrhardt and Weber, Suite 204, 302 Campusview Drive, Columbia, MO, 65201, US

(21) Appl. No.: 12/384,875

(22) Filed: Apr. 9, 2009

Related U.S. Application Data
(60) Provisional application No. 61/124,130, filed on Apr. 15, 2008.

(51) Int. Cl. B60P 7/02

(52) U.S. Cl. 296/100.07

(57) ABSTRACT

An aerodynamic truck bed enclosure, the preferred embodiment includes a single piece of fiberglass or other suitable material secured to the truck bed with parallel hinges which allow the enclosure to be raised from the rear of the truck bed to access cargos.

### CROSS-REFERENCE TO RELATED APPLICATIONS

This application claims the priority of Provisional Application Ser. No. 61/124,130 filed on Apr. 15, 2008.

### STATEMENT REGARDING FEDERALLY SPONSORED RESEARCH FOR DEVELOPMENT

Not Applicable

### THE NAMES OF THE PARTIES TO A JOINT RESEARCH AGREEMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The invention relates to the field of pickup truck bed covers. Pickup trucks are popular vehicles in part because of their ability to haul cargo in their open bed located behind the truck's cab. However, because of its open nature, truck-users often desire to cover their truck bed to protect their hauled cargo from the elements and perhaps potential thieves. For years, a popular method of covering a truck bed has been to install a camper shell. A camper shell is a rigid covering that encloses a truck bed from just behind the truck's cab to the tailgate.

Despite this protective advantage, camper shells have disadvantages as well. For one, camper shells limit access to the cargo in the bed of the truck due to their total envelopment of the truck bed. In most camper shells, access to the bed of the truck is typically provided through a single access door or opening. This access door or opening, often a window that is hinged at its top so that it can be opened to provide access, is typically located at the rear of the vehicle above the tailgate of the truck. This single opening essentially limits access to an individual's arm length. However, in addition to this camper shell opening, the truck's tailgate can be lowered to provide users with greater access. Despite this increase however, access to cargo items not located in the immediate rear vicinity of the truck is still limited. Therefore, for items located near the cab of the truck, the user may have to climb into the truck bed and duck under the camper shell in order to access the item. Unlike an open truck bed without a camper shell, a user cannot simply reach over the side of the bed to retrieve the item.

Another disadvantage of camper shells is that they typically create additional wind resistance when the truck is driven. This obviously reduces fuel economy. With today's gas prices being at record levels, reduced fuel economy is highly undesirable. Camper shells also increase the overall weight in the truck bed. This effect both reduces fuel economy and increases wear and tear on the load bearing parts of the truck such as the suspension system. The price of a typical camper shell is yet another disadvantage. Camper shells can often cost $1000 or more. They are a significant financial investment for a truck-user. Furthermore, they can be difficult to resell if the user later decides he or she does not want the camper shell. Lastly, camper shells can be difficult to install due to their size, shape and weight. Truck-users often opt to have professional dealers install their camper shells for them, thereby further increasing their already significant financial outlay.

### BRIEF SUMMARY OF THE INVENTION

The invention addresses all of the above-mentioned disadvantages of typical truck bed camper shells as well as having a number of other benefits to boot. The enclosure body comprises a single piece and can be made from any suitable material. The preferred exemplary embodiment that is discussed in detail below contemplates a fiberglass design due to the strength, availability, low weight and relatively low cost of fiberglass. The enclosure body is molded into a rounded tear-drop like shape. When attached to a truck bed, the invention creates air foil much like that of an airplane wing. This unique shape and one-piece construction provides truck-users with several benefits as opposed to the typical camper shell. First, it is much more aerodynamic than a typical camper shell. In fact, it should even increase fuel economy over an open truck bed. Additionally, the airfoil design may create a small amount of lift at the rear of the truck when the truck is moving thereby reducing wear and tear on the load bearing components, such as bearings and suspension. The one-piece construction also provides for a lower cost as well as a lighter and stronger design than a conventional camper shell.

The preferred embodiment of the invention also addresses the issue of limited accessibility seen in typical camper shells. In this embodiment, the enclosure is attached to each side of the truck bed by a parallel hinge at or near the front of the bed. The parallel hinges allow the truck user to open the enclosure much like a hatch back on an automobile. The hinges allow the enclosure to be raised vertically just enough so that the back side of the enclosure will clear the roof of the truck cab. The hinges then allow the enclosure to swing open like a hatch back. This allows increased access by way of the sides of the truck bed. Finally, it is contemplated that an electric motor, with or without a remote control, could be used to open and close the enclosure.

### BRIEF DESCRIPTION OF THE SEVERAL VIEWS OF THE DRAWING

The novel features believed to be characteristic of the present invention, together with further advantages thereof will be better understood from the following description and in connection with the accompanying drawings in which the preferred embodiment of the invention is illustrated by way of example. It is to be expressly understood, however, that the drawings are for the purpose of illustration and description only and are not intended as the definition of the limits of the invention.

FIG. 1 is a side view of the enclosure body.

FIG. 2 is a front view of the enclosure body.

FIG. 3 is a rear view of the enclosure body.

FIG. 4 is a top view of the enclosure body.

FIG. 5 is a side view of the enclosure body mounted on truck and in the closed position.

FIG. 6 is a side view of the enclosure body mounted on truck and in the open position.

FIG. 7 is an embodiment of parallel hinge assembly.

### DETAILED DESCRIPTION OF THE PREFERRED EMBODIMENT

The ensuing description provides one preferred exemplary embodiment only and is not intended to limit the scope, applicability or configuration of the invention. Rather, the ensuing description of the exemplary embodiment will provide those skilled in the art with an enabling description for implementing an exemplary embodiment of the invention. It should be understood that various changes may be made in the function and arrangement of the elements without departing from the spirit and scope of the invention.

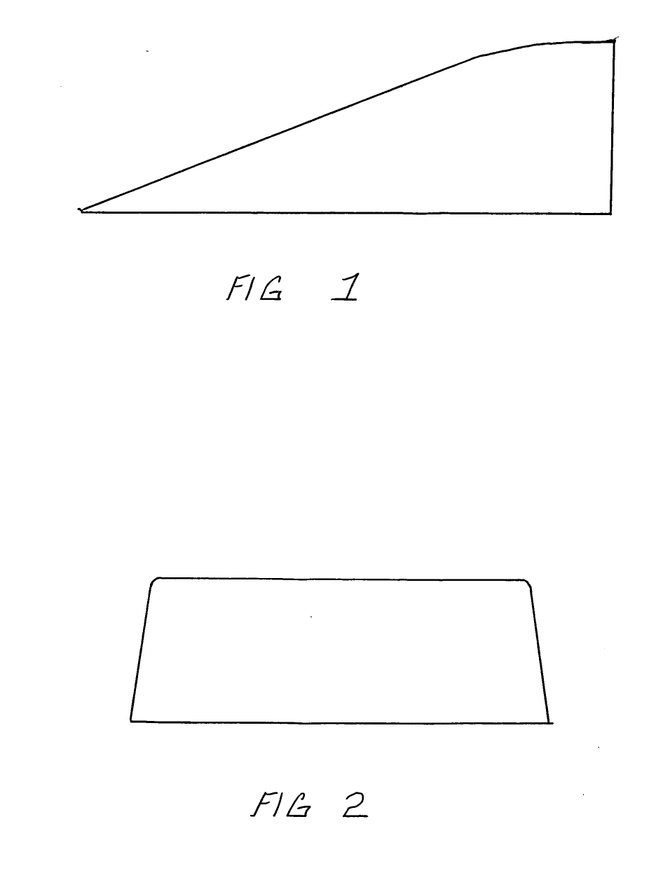

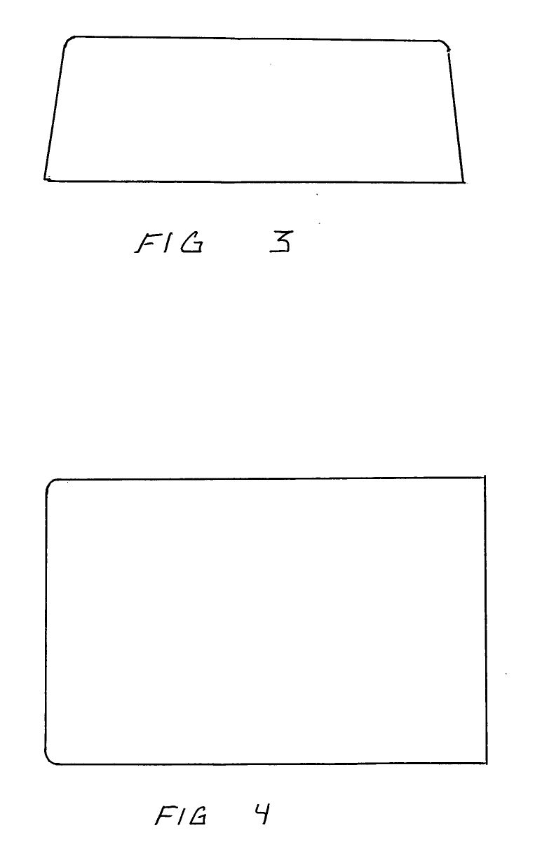

FIG. 1, FIG. 2, FIG. 3 and FIG. 4 illustrate the preferred exemplary embodiment of the enclosure body from the side, front, rear and top angles respectively. The preferred exemplary embodiment has a curved top that begins at the roof of the truck cab and curves down toward the rear. The preferred exemplary embodiment is also sloped on the sides as depicted in FIG. 3 and FIG. 4. The curvature and sloped sides are intended to increase the aerodynamics of the enclosure. The amount of curvature and slope can vary depending on the size and type of truck to which the invention is attached as well as on the preference of the user.

FIG. 5 illustrates the side view of the enclosure body 500 mounted on a pickup truck 501 in the closed position. This is the position used while driving. The curvature and slope of the invention creates an air foil in this position similar to that of an airplane wing. This shape is very aerodynamic and may create some lift at the rear end of the truck when the truck is driven. The exemplary preferred embodiment shown of invention 500 is particularly aerodynamic because its smooth curves and tear drop shape returns the air displaced by the front of the truck in a smooth and efficient manner.

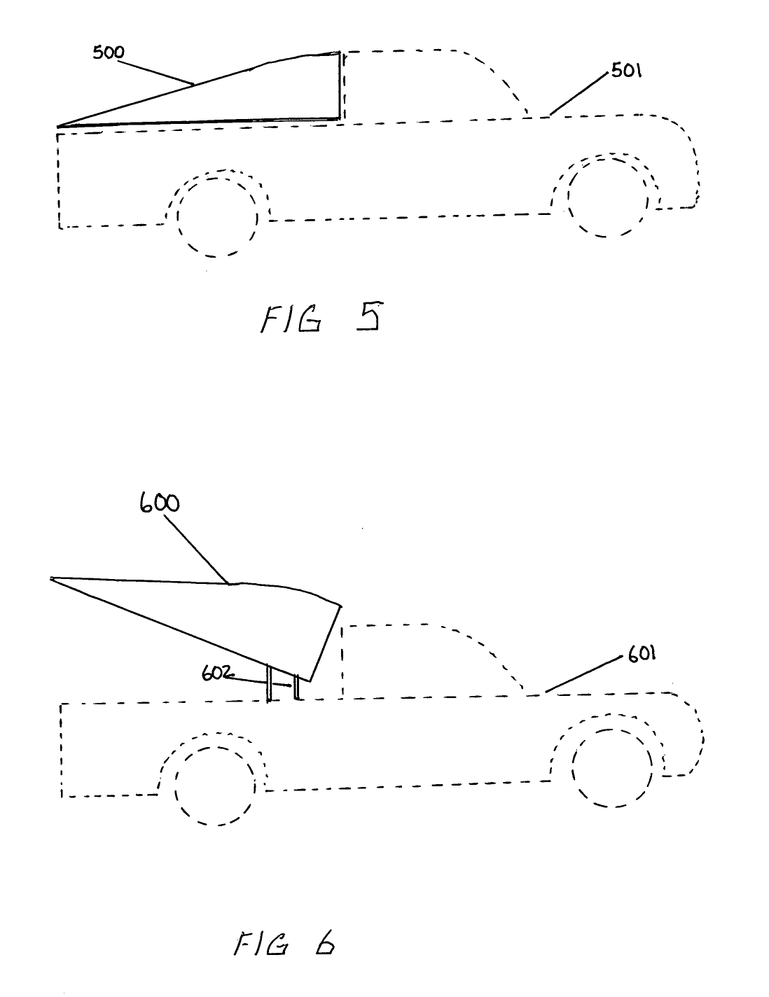

FIG. 6 illustrates the enclosure body 600 mounted on a pickup truck 601 in the open position. The parallel hinges 602 are mounted on either side of the pickup truck bed at or near the front of the truck bed which allow the enclosure to be opened much like a hatch back on an automobile. The hinges move in two directions as the enclosure 600 is opened. First, the hinges move vertically or near vertically and back. This allows the front of the enclosure to clear the roof of the truck as the hinge moves in the second direction. Then the hinge moves the rear of the enclosure up vertically and rotates the front of the enclosure (near the cab) on an axis in the bottom.

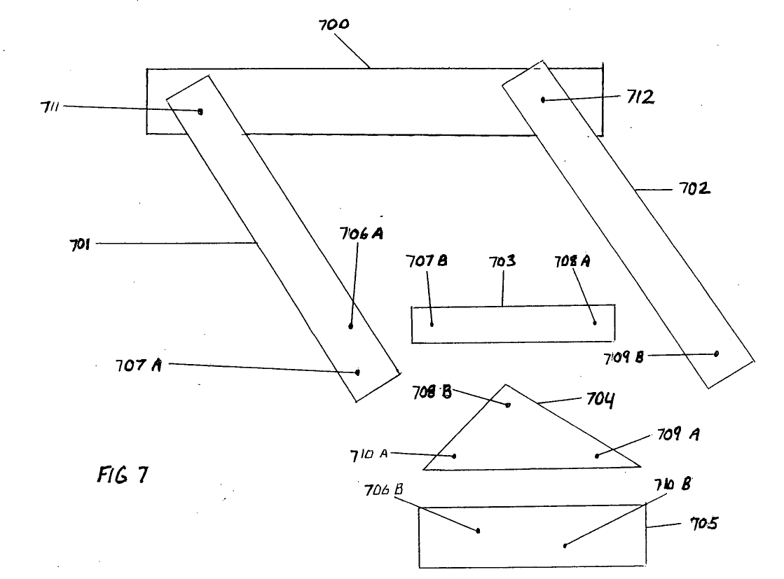

FIG. 7 illustrates an exemplary embodiment of the parallel hinge assembly for the invention. Upper mounting flange 700 mounts to the inside wall of the side of the enclosure and lower mounting flange 705 mounts to the inside of the wall of the truck bed. Side piece 701 and side piece 702 mount to upper bracket 700 in such a way to allow for their rotation on their axes 711 and 712 as the hinge is opened or closed. Side piece 701 attaches to lower bracket 705 at the axis created by the attachment of 706A and 706B. Side piece 701 attaches to center bar 703 at the axis created by the attachment of 707A and 707B. Side piece 702 attaches to center triangle 704 at the axis created by the attachment 709A and 709B. Center bar 703 attaches to center triangle 704 at the axis created by the attachment of 708A and 708B. Center triangle 704 attaches to lower mounting bracket 705 at the axis created by the attachment of 710A and 710B.

Although the invention has been described with reference to particular ingredients and formulations and the like, these are not intended to exhaust all possible arrangements or features, and indeed many other modifications and variations will be ascertainable to those of skill in the art.

I claim:

1) An aerodynamic truck bed cover device comprising: a single molded shell and a means for securing said shell to a pick up truck bed.

2) An aerodynamic truck bed cover device according to claim 1, wherein: said means for securing said shell to a pick up truck bed comprises two parallel hinges mounted on opposite sides of the pick up truck bed which allow the enclosure to be opened and closed.

3) An aerodynamic truck bed cover device according to claim 1 or 2, wherein: said means for securing said shell to a pick up truck bed further comprises an electric motor for opening and closing the enclosure.

4) An aerodynamic truck bed cover device according to claim 1, 2 or 3, wherein: said means for securing said shell to a pick up truck bed further comprises an electric motor with a wireless remote control.

5) An aerodynamic truck bed cover device according to claim 1, 2, 3 or 4 wherein: said shell is constructed from fiberglass.
